(19) United States
(12) Patent Application Publication
(10) Pub. No.: US 2009/0313394 A1
(43) Pub. Date: Dec. 17, 2009

(54) Computer Device and Control Method for Connecting Computer Peripheral Equipment

(75) Inventors: Li Pin Yeh, Taipei (TW); Jiun Da Shr, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ASUSTEK COMPUTER INC., Taipei (TW)

(21) Appl. No.: 12/465,904

(22) Filed: May 14, 2009

(30) Foreign Application Priority Data
Jun. 13, 2008 (TW) 97122245

(51) Int. Cl. G06F 3/00; G06F 13/38

(52) U.S. Cl. 710/16; 710/63

(57) ABSTRACT

A computer device and a control method for connecting computer peripheral equipment are provided. The computer device is used to be connected to the peripheral equipment, and it includes a connecting interface, a memory module storing a plurality of nonresident applications, a detecting module having a TSR detecting program and a retrieving module. When the TSR detecting program detects that the connecting interface is coupled to peripheral equipment, a detecting signal is generated. The retrieving module retrieves the nonresident applications corresponding to the peripheral equipment from the memory module according to the detecting signal and executes the nonresident applications.

### CROSS REFERENCE TO RELATED APPLICATION

This non-provisional application claims priority under 35 U.S.C. § 119(a) on Patent Application No(s). 97122245 filed in Taiwan, R.O.C. on Jun. 13, 2008, the entire contents of which are hereby incorporated by reference.

### BACKGROUND OF THE INVENTION

1. Field of the Invention

The invention relates to a computer device and a control method and, more particularly, to a computer device connected to peripheral equipment and a control method for connecting computer peripheral equipment.

2. Description of the Related Art

With the increase of peripheral equipment for a computer, different applications need to be installed in a computer system to satisfy different peripheral equipment. To USB peripheral equipment, since USB peripheral equipment has a plug and play function, more and more peripheral equipment uses the USB connecting interface to be connected to the computer. To achieve the plug and play function, most of the applications needed by the USB peripheral equipment stay resident in the system memory to be retrieved at any time. That is, most of the applications corresponding to the USB peripheral equipment are terminate and stay resident (TSR) programs.

The TSR program is a program that is loaded in the system memory as soon as the computer is booted. The TSR application stays resident in the computer system even though it is not used. Thus, the computer boot speed may decrease due to the TSR program, and computer and memory resource also may be consumed by the TSR program.

To improve the boot speed of the computer and save the computer resource and memory space, the execution of the TSR program needed by the USB peripheral equipment may be stopped. However, when the user connects the USB peripheral equipment to the computer system to use the USB peripheral equipment, troublesome starting steps may be performed before the USB equipment may be used successfully. This increases the inconvenience in usage.

### BRIEF SUMMARY OF THE INVENTION

The invention provides a computer device used to be connected to peripheral equipment. The computer device includes a connecting interface, a memory module storing a plurality of nonresident applications, a detecting module having a TSR detecting program and a retrieving module. When the TSR detecting program detects that the connecting interface is coupled to the peripheral equipment, the TSR detecting program generates a detecting signal. The retrieving module retrieves the nonresident applications corresponding to the peripheral equipment from the memory module according to the detecting signal and executes the nonresident applications.

The invention also provides a control method for connecting computer peripheral equipment adapted for a computer device. The computer device includes a connecting interface, a memory module storing a plurality of nonresident applications and a detecting module having a TSR detecting program. The control method includes the steps as follows. The TSR detecting program is executed. When the TSR detecting program detects that the connecting interface is coupled to the peripheral equipment, the TSR detecting program generates a detecting signal. The computer device retrieves the nonresident applications corresponding to the peripheral equipment according to the detecting signal and executes the nonresident applications.

In the device or method provided in the invention, when a user uses the USB peripheral equipment, even if the application corresponding to the USB equipment is a nonresident application, the application also may be executed automatically. Thus, a plug and play objective is achieved. Therefore, even though the application is nonresident, the troublesome operation steps are omitted, the boot speed of the computer is not decreased, and the system resource that is occupied by the TSR program is also saved.

These and other features, aspects and advantages of the present invention will become better understood with regard to the following description, appended claims, and accompanying drawings.

### BRIEF DESCRIPTION OF THE DRAWINGS

FIG. 1 is a schematic diagram showing a computer device in a first embodiment of the invention;

FIG. 2 is a schematic diagram showing a computer device in a second embodiment of the invention; and

FIG. 3 is a flow chart showing the control method for connecting the computer peripheral equipment.

### DETAILED DESCRIPTION OF THE EMBODIMENTS

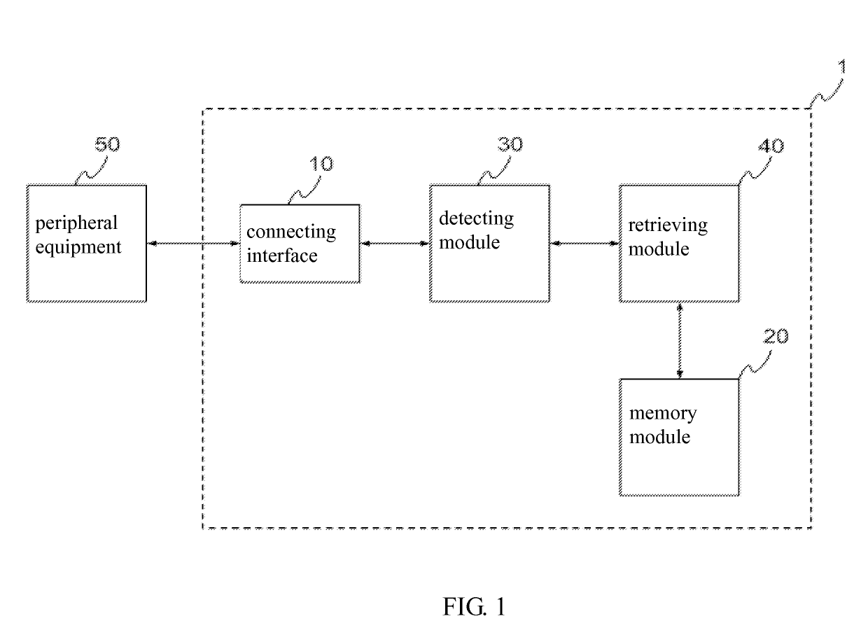

FIG. 1 is a schematic diagram showing a computer device in a first embodiment. As shown in FIG. 1, the computer device 1 provided in the invention is used to be connected to peripheral equipment 50. The computer device 1 includes a connecting interface 10, a memory module 20, a detecting module 30 and a retrieving module 40.

The connecting interface 10 allows the peripheral equipment 50 having an identification code to be coupled to the computer device 1. That is, the peripheral equipment 50 may be coupled to the connecting interface 10 to be electrically connected to the computer device 1. The connecting interface 10 may be a USB connecting interface, and the peripheral equipment 50 coupled to the connecting interface 10 is USB equipment. In addition, identification codes belonging to different peripheral equipment 50 may be vendor identification codes (vendor ID) or product identification codes (product ID), and they are not limited thereto.

The memory module 20 stores a plurality of applications. The applications stored in the memory module 20 herein are not TSR programs. When the applications are needed, they are loaded from the memory module 20. These programs are called nonresident programs. The memory module may be any storage block in the hard disk or one of different storage modules such as a RAM, a ROM or an EPROM, and it is not limited thereto.

The detecting module 30 may be designed to be a simple detecting software program which stays resident in the system memory to detect if the connecting interface 10 is coupled to the peripheral equipment 50. When the peripheral equipment 50 is coupled to the connecting interface 10, a detecting signal is generated to notice the computer device 1 that the peripheral equipment 50 is connected to the computer device 1, and the following action may be performed. Since the detecting module 30 is a simple detecting software program, the space which is occupied by the detecting module 30 is much less than the space occupied by the TSR program corresponding to the USB device. When needed, the applications are retrieved from the memory module 20 which stores a plurality of applications. Thus, the troublesome operation steps are omitted, the boot speed of the computer does not decrease, and system resource that is occupied by the TSR program is saved.

When the detecting module 30 detects that the connecting interface 10 is coupled to the peripheral equipment 50, the detecting signal is transmitted to the retrieving module 40. At that moment, the retrieving module 40 retrieves the application from the memory module 20 according to the detecting signal. The retrieved application corresponds to the identification code of the coupled peripheral equipment 50. Then, the computer device 1 executes the retrieved application automatically.

In the invention, the application needed by the peripheral equipment 50 is stored in the memory module 20 to make the application to be a nonresident program. Thus, when the peripheral equipment 50 is not coupled to the computer device 1, and namely the peripheral equipment 50 is not used, the application is not a TSR program, and it does not consume the computer system resource as in the prior art. In addition, in the prior art, if the application needed by the peripheral equipment 50 is nonresident, the plug and play function cannot be achieved. However, the computer device in the invention may allow the peripheral equipment 50 to have the plug and play function, and it also may save the system resource that is occupied by the TSR program when the TSR program is not used. When the peripheral equipment 50 is coupled to the connecting interface 10, the detecting module 30 generates a detecting signal, and the retrieving module 40 retrieves the application corresponding to the identification code from the memory module 20 and executes the application automatically. Thus, in the invention, according to different peripheral equipments 50, different applications are retrieved to be corresponding to the peripheral equipment 50 having different functions. Thus, the user may use different peripheral equipments 50 easily without clicking the applications manually or knowing the storing path of the applications.

For example, supposing that the peripheral equipment 50 is a USB phone, and the application corresponding to the USB phone is the MSN, the Skype and other instant message (IM) programs. Conventionally, the IM programs such as the MSN or Skype which may be used by USB phones are set to be TSR programs, and as soon as the USB phone is connected to the computer device 1, the corresponding application is executed instantly. However, this may reduce the boot speed and waste the system resource. If the MSN or Skype and other applications are not set to be TSR programs, when the user couples the USB phone to the connecting interface 10, the computer system does not execute the application such as the MSN or the Skype automatically, and the user has to find the storage path of the corresponding applications and click the application manually to make the computer execute the applications. This makes it inconvenient in usage.

Thus, in the computer device of the invention, after the USB phone is coupled to the connecting interface 10, an application such as the MSN or the Skype corresponding to the USB phone is retrieved from the memory module 20 by the detecting module 30 and the retrieving module 40. Thus, the application such as the MSN or the Skype may be executed automatically. To a user, the plug and play function also may be kept, and to the computer system, the application such as the MSN or the Skype is nonresident, the resource of the computer system is saved, and the boot speed does not decrease.

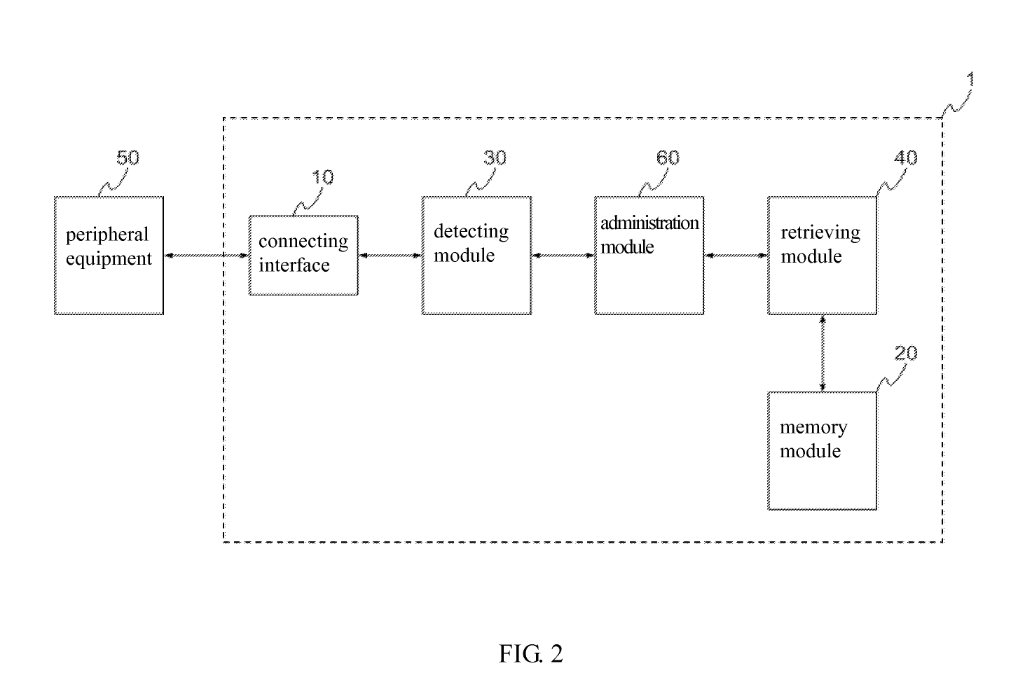

FIG. 2 is a schematic diagram showing a computer device in a second embodiment of the invention. As shown in FIG. 2, the second embodiment also includes an administration module 60.

The administration module 60 determines if the identification code of the peripheral equipment 50 coupled to the connecting interface 10 is identifiable. When the identification code of the coupled peripheral equipment 50 is identifiable, it means that the computer device 1 allows the peripheral equipment 50 to be used. Thus, the retrieving module 40 retrieves the corresponding application from the memory module 20 and executes the application automatically to start the peripheral equipment 50. Relatively, when the identification code of the peripheral equipment 50 is not identifiable, it means that the computer device 1 does not allow the peripheral equipment 50 to be used. Thus, the retrieving module 40 does not retrieve the application or start the coupled peripheral equipment 50. That is, the administration module 60 controls whether the retrieving module 40 retrieves the application or not to manage the peripheral equipment.

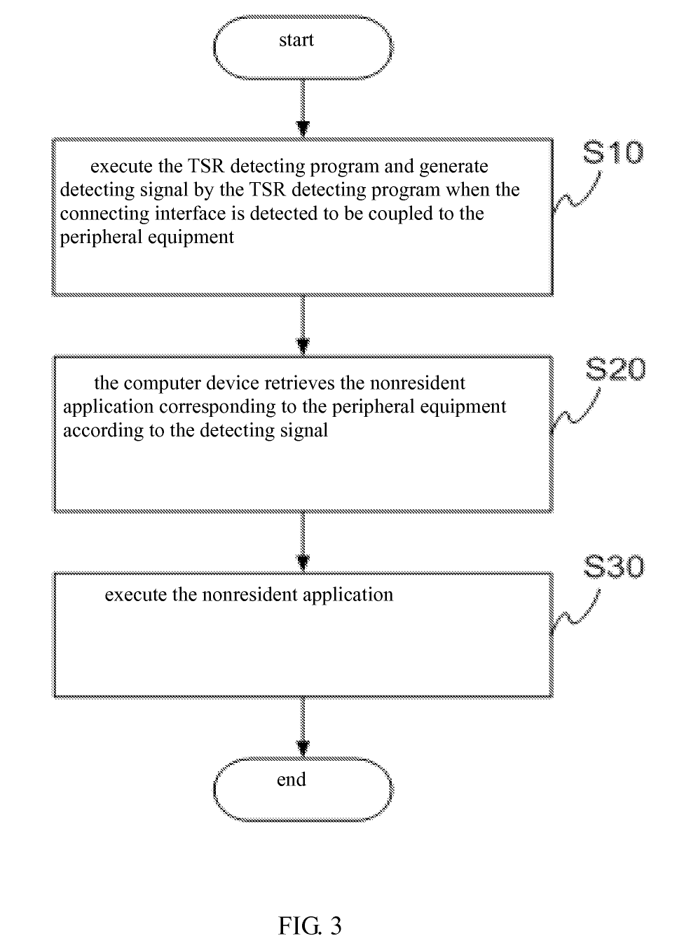

FIG. 3 is a flow chart showing the control method for connecting the computer peripheral equipment. As shown in FIG. 3, the control method is adapted to the computer device, and the computer device includes a connecting interface, a memory module storing a plurality of nonresident applications and a detecting module having a TSR detecting program. The control method includes the steps as follows.

In step S10, the TSR detecting program is executed. When the connecting interface is detected to be coupled to the peripheral equipment, the TSR detecting program generates the detecting signal. The connecting interface may be a USB connecting interface, and it may be used to be coupled to the USB device.

In step S20, the computer device retrieves the nonresident application corresponding to the peripheral equipment. The nonresident application may be an IM program, and it is not limited thereto.

In step S30, the nonresident application is executed.

In step S10 above, when the connecting interface is detected to be coupled to the peripheral equipment, the following step also may be performed. That is, whether the identification code of the peripheral equipment coupled to the connecting interface is identifiable is detected. When the identification code is identifiable, the computer device retrieves the nonresident applications corresponding to the identification code. When the identification code is not identifiable, it means that the coupled peripheral equipment is not allowed to be used by the computer device, and the corresponding nonresident applications are not retrieved, and the peripheral equipment is not started. Thus, the peripheral equipment may be managed. The identification code herein may be a vendor ID or a product ID.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A computer device used to be connected to peripheral equipment, the computer device comprising:
a connecting interface;
a memory module storing a plurality of nonresident applications;
a detecting module having a terminate and stay resident (TSR) detecting program, wherein when the TSR detecting program detects that the connecting interface is coupled to the peripheral equipment, the TSR detecting program generates a detecting signal; and
a retrieving module retrieving the nonresident application corresponding to the peripheral equipment from the memory module according to the detecting signal and executing the nonresident application.

2. The computer device according to claim 1, further comprising:
an administration module determining if an identification code of the peripheral equipment coupled to the connecting interface is identifiable to control the retrieving module to retrieve the nonresident application corresponding to the identification code or not.

3. The computer device according to claim 2, wherein the identification code is a vendor identification code (ID).

4. The computer device according to claim 2, wherein the identification code is a product ID.

5. The computer device according to claim 1, wherein the connecting interface is a universal serial bus (USB) connecting interface.

6. The computer device according to claim 1, wherein the nonresident applications are immediate message (IM) programs.

7. The computer device according to claim 1, wherein the TSR detecting program of the detecting module is stored in a system memory.

8. The computer device according to claim 1, wherein the memory module is a hard disk.

9. A control method for connecting computer peripheral equipment adapted for a computer device including a connecting interface, a memory module storing a plurality of nonresident applications and a detecting module having a TSR detecting program, the control method comprising the steps of:
executing the TSR detecting program and generating a detecting signal by the TSR detecting program when the connecting interface is detected to be coupled to the peripheral equipment;
retrieving the nonresident application corresponding to the peripheral equipment by the computer device according to the detecting signal; and
executing the nonresident application.

10. The control method for connecting the computer peripheral equipment according to claim 9, wherein generating a detecting signal by the TSR detecting program when the connecting interface is detected to be coupled to the peripheral equipment, the control method further comprises the step of:
determining if an identification code of the peripheral equipment coupled to the connecting interface is identifiable.

11. The control method for connecting the computer peripheral equipment according to claim 10, wherein the identification code is a vendor ID.

12. The control method for connecting the computer peripheral equipment according to claim 10, wherein the identification code is a product ID.

13. The control method for connecting the computer peripheral equipment according to claim 9, wherein the connecting interface is a USB connecting interface.

14. The control method for connecting the computer peripheral equipment according to claim 9, wherein the nonresident applications are instant message (IM) programs.
